(19) United States
(12) Patent Application Publication
(10) Pub. No.: US 2022/0264915 A1
(43) Pub. Date: Aug. 25, 2022

(54) METHOD FOR OBTAINING A FOOD PRODUCT WITH A HIGH FIBRE CONTENT AND FOOD PRODUCT OBTAINABLE WITH THIS METHOD

(71) Applicant: CIRCULAR FOOD SRL, Castelfranco Veneto (IT)

(72) Inventors: Vittorio COGO, Cassola (IT); Matteo DALLA RIZZA, Bassano del Grappa (IT)

(21) Appl. No.: 17/629,925

(22) PCT Filed: Jul. 23, 2020
(86) PCT No.: PCT/IB2020/056970

§ 371 Date: Jan. 25, 2022

(30) Foreign Application Priority Data
Jul. 26, 2019 (IT) 102019000013113

(51) Int. Cl. A23L 7/104; A23L 7/20; A23L 5/30

(52) U.S. Cl. CPC A23L 7/107; A23L 7/20; A23L 5/36; A23V 2002/00

(57) ABSTRACT

A method for obtaining a food product from a wet mass of waste materials arising from production processes for producing products like beer, whisky, vodka, gin, tequila, liqueurs or citrus-fruit based distillates, cider, sake, soy sauce is provided. An enzyme is added to the waste materials that is suitable for breaking down possible gluten residues in the materials and making the enzyme act for a period between 15 and 30 minutes. The waste materials are boiled for at least 20 minutes. The waste materials are cooled and centrifuged to eliminate most of the water present in the waste materials. The materials are dried at a temperature between 70° C. and 100° C. for a time between 60 and 120 minutes, by a radio frequency dryer so as to obtain, at the end of drying, a product with relative humidity between 14 and 2%. A food product is provided that includes a percentage by weight between 1% and 60% of at least one flour obtainable from waste materials arising from the production processes for producing products like beer, whisky, vodka, gin, tequila, liqueurs or citrus-fruit based distillates, cider, sake, soy sauce, and at least one cereal flour, or vegetable flour, or animal flour, in a percentage by weight between 40% and 99%.

### CROSS-REFERENCE TO RELATED APPLICATIONS

This application claims priority to Application No. PCT/IB2020/056970 filed Jul. 23, 2020. Application No. PCT/IB2020/056970 claims priority to Application No. IT102019000013113 filed on Jul. 26, 2019. The entire content of these applications is incorporated herein by reference.

### BACKGROUND OF THE INVENTION

The present invention relates to a method for obtaining a food product with a high fibre content by using waste by-products of other food processes.

The technical field of the present invention relates to the sector of the production of alcoholic or fermented beverages or the sector relating to all those techniques, methods and components linked to the production of beer, whisky, vodka, cider, liqueur, or citrus fruit distillate, soy sauce and sake.

The procedures for preparing the aforesaid beverages are very similar and are disclosed below.

### Beer

The following ingredients are generally used to brew beer:

water

cereals (barley, rye, wheat, maize, oats)

hops

yeast

Initially, the grains of barley malt and of other cereals that are possibly used are milled so as to make the starch contained therein available. The milled cereal is then mixed with hot water to enable the enzymes to be activated that are contained in the malt, during the so-called mashing step. Different enzymes in fact exist in malt, each with a different action, which operate in an optimum manner at different temperatures and different pH. The most important in the beer brewing sector are the diastase enzymes that break down the starches of the cereal in sugars. Once the starch has been transformed into sugars, the obtained mixture is filtered to separate the sugar mash from the so-called brewers' grains, i.e. the mashing residue consisting of the malt peelings and of other parts of the cereal for which saccharification does not occur. For more effective action, the first (cloudier) mash is usually subjected to further filtrations that enable the sugars to be recovered that remain imprisoned in the brewers' grains after the first filtration. Although the filtering operations are very simple they play an essential part in the process of producing beer, in fact, it is essential to prevent brewers' grains passing into the mash and thus into the subsequent boiling steps because they would cause tannins and other bitter substances to be released into the finished beer that would give rise to a product with an undesired astringent taste.

Lastly, the mash is boiled, hops are added, the mash is transferred to the fermenters, cooled by a heat exchanger to the temperature that is suitable for the chosen type of fermentation (high 18-25° C. or low 7-15° C.) and is suitably oxygenated. The mash is considered to be ready for the addition of yeast and for the fermentation step, which can have a further processing step known as “dry hopping” that consists of cold adding the hop pellets to give the beer further aromas.

During production of the beer, in addition to recovering the spent barley malt, which is also known as brewers' grains, it is possible to recover all the hops used, both hot and cold used.

In the final processing, during filtration of the beer, the hops can be recovered and stored, maintaining the hot cycle during the step of boiling filtering, and cold filtering after cold hopping, which is also called “dry hopping”.

Once filtered, the hops are like a vegetable purée that can be easily dried by the radio frequency method and be subsequently milled.

The type of flour that is obtained is rich in fibre (over 50%), and low in carbohydrates and proteins.

The mashing residue, which is separated from the beer before boiling, consisting of malt peelings and of other parts of the cereal on which saccharification does not occur, i.e. so-called “brewers' grains of beer”, subjected to the processing procedure according to the invention disclosed hereafter, gives rise to a flour that will be called “spent barley malt flour”.

The residue of the filtering of the beer after hopping, consisting of a vegetable purée of hops, subjected to the processing procedure according to the invention, gives rise to a flour that will be called “hops flour”.

Mixing the two types of flour in percentages between 90% and 99% for spent barley flour and between 1% and 10% for the hops flour gives rise to a flour that can be defined as “beer flour” because it is the result of the integral use of the products arising from the production of beer.

### Whisky

The following ingredients are generally used to produce whisky:

water

cereals (barley, rye, wheat, maize)

yeast.

There are generally 5 steps in whisky making that are defined as follows:

Malting

The barley that has been previously loaded and stored in silos is loaded inside tanks of lukewarm water that are commonly known as steeps.

The barley remains in these steeps for about 48 hours so that it can macerate and the germination process can start.

After the time has elapsed that is necessary for maceration, the cereal is separated from water and is spread uniformly (in layers of about 50 cm) on a cement, tile or stone floor called “malting house” where it will remain for the time necessary for the sprout to perforate the film of the seed, thus enabling the enzymes and starches to enter the interior thereof.

After a few days from the start of the germination step, it is interrupted by the use of a dryer that is often powered by burning peat.

At this point, a dried raw product will be obtained that will be milled to obtain a rough flour called grist.

Malt Infusion

The malted and milled barley (grist) is immersed in water inside metal tanks known as “mash tuns” at a temperature comprised between 65° and 70°, this process enables the starches to be transformed into sugars that, once they are dissolved in water, are removed by removing and adding hot water to the tank three times.

The end product that will be obtained is called mash in jargon.

Before entering the fermentation step, the mash is stabilized by a heat exchanger at a temperature of about 20° so as to ensure the durability of the life of the yeast because if the temperature of the mash were too high, the action of the yeast would be thwarted because the yeast would die too quickly.

Fermentation

At this point, the heated mash is moved inside tanks known as vats in which a water and yeast solution is added.

The yeast is used to convert the starches first into sugar and then into alcohol and carbon dioxide.

Owing to this chemical reaction, the temperature of the mixture increases until it reaches 35°.

The duration of this process can vary from a minimum time of 48 hours to a maximum time of 112 hours and the degree of alcohol obtained at the end of fermentation is comprised between 6 and 9 degrees of alcohol.

Subsequently to fermentation, the liquid is separated from the spent cereals (barley, rye, wheat and maize) by filtering.

The resulting liquid commonly known as “wash” could be transformed into beer. The difference between whisky and beer is that in whisky this liquid is distilled instead of being fermented.

Distillation

Distillation occurs through a first copper still and a second copper still connected together owing to a condenser formed by a tube that is also of the same material of which the stills are made and is cooled by coils or immersed in tanks containing water.

The distilling process develops in the following manner:

the first still is used to boil the mash until it is brought to an alcohol content of about 20% by volume;

the alcohol in the form of steam is made into liquid owing to the condenser, the product resulting from this first distillation is called “low wine”.

It is mixed with the residue of the preceding distillation until 30% alcoholic content by volume is reached, at this point the mixture is introduced into the second still and is boiled again.

Once the content of the second still has been boiled, the distilling process mentioned above is run again, but ensuring that the first part of liquid is removed that is called the head in the jargon, which is normally obtained below 78.4° C. in temperature, because it contains methyl alcohol that is a very harmful substance for the human body and the final part that is called tail in the jargon and is usually obtained above 95° C., which would give the end product a bad taste, thus only the central part is retained of the distillate obtained between 78.4° C. and 95° C., which is commonly called the heart, which has a limpid and pure appearance with an alcohol content between 70% and 75% by volume.

The product that is distilled from the second still is diluted with water until an alcohol content that is comprised between 60% and 64% by volume is obtained that is considered the optimum value for ageing in barrels.

The residue of the filtering process, consisting of spent fermented barley, rye, maize and wheat, subjected to the processing procedure according to the invention, gives rise to a flour that will be called “whisky flour”.

### Soy Sauce

The basic ingredients for producing this condiment, according to the classic method, are:

soya beans, water, wheat, marine salt, koji (a mushroom).

After being thoroughly washed, the soya is soaked in water to rehydrate it and, subsequently, it is steamed slowly and for a long time (about 3 or 4 hours).

After the soya beans have been taken to boiling point, wheat is taken, roasted and milled.

When the heart of the cooled soya has reached a temperature of about 30-35° C., it is mixed with the toasted and milled wheat and the koji (filamentous mushroom) that, during fermentation by enzymes, converts the proteins into amino acids, whilst the starches are broken down into simple sugars and subsequently fermented.

After the koji has been added, all the ingredients are left to rest for a period comprised between 48 and 72 hours and lastly a mixture of water and salt is added.

The mixture is left to ferment for at least 12 months inside barrels in order to ensure the correct amalgamation of all the ingredients and the escape of the gases created by fermentation.

After the fermentation period, this mixture is pressed through a thin mesh filter that ensures a correct separation of the liquid part from the solid part.

In order to market soy sauce, the soy sauce is filtered again to eliminate also the finer residues, at the end the soy sauce is pasteurized.

However, other methods for producing soy sauce exist, for example in the industrial context other ingredients are used like acidity correctors, ethanol and sugar to limit the massive use of salt that is encountered in the “classic” method, but ensuring the correct conservation thereof.

The residue of the filtering process, consisting of spent soya beans, wheat and koji subjected to the processing procedure according to the invention gives rise to a flour that will be called “soya flour”.

### Vodka and Gin

### Vodka

Vodka can be obtained by processing different raw materials, provided that they are rich in starch and sugars. The most commonly used raw materials are suitably malted cereals (rye, barley and wheat), and potatoes.

The productive process starts with rough shredding of the raw materials (rye, barley and wheat or potatoes), after which they are covered with water that is as pure as possible and left to macerate until the liquid portion takes on a yellowish and dense appearance.

After the time has elapsed that is necessary for correct maceration of the raw materials used, the solid part is divided from the liquid part using filters, the mash being thus obtained.

The mash is placed inside a steel tank, the yeasts are added and the mash is left to ferment at a controlled temperature until the alcohol concentration thereof reaches 6-8% by volume.

Distillation occurs in a first copper still and a in second copper still that are connected to one another by a condenser consisting of a pipe that is also of the same material of which the stills are made and is cooled by coils or placed in tanks containing water.

The distillation process develops in the following manner:

the first distiller is used to boil the mash until it is possible to take the mash to an alcohol content equal to about 20% by volume.

The alcohol in the form of steam is made liquid owing to the condenser but, also in this case, the first part of liquid has to be removed that in the jargon is called head, which is normally obtained below 78.4° C. in temperature, because it is saturated in methanol, a toxic substance that is very harmful to the human body, and the end part, which in jargon is known as the tail and is usually obtained above 95° C. and which is saturated in toxic substances like fusel oil. Only the central part, defined in jargon as the “heart” of the distillate, is retained that is obtained between 78.4° C. and 95° C.

This process is repeated from 4 to 8 times depending on the decision of the master distiller to reach an alcohol content comprised between 94° and 97°.

At the end of distillation, the distillate is purified with carbon filters to eliminate any distilled taste and is diluted with water until it reaches the desired alcoholic content.

The residue of the filtering process to obtain the mash, consisting of spent rye, barley and wheat or potatoes, subjected to the processing procedure according to the invention, gives rise to a flour that will be called “vodka flour”.

### Gin

Gin is an alcoholic beverage obtained by the same process of distillation of vodka, starting from the same raw materials.

The substantial difference is that in gin, during the maceration step, there necessarily has to be a botanical mixture (herbs, spices, plants, berries and roots) that has to include juniper berries that give the scent and taste.

Further, whereas in vodka it is necessary to filter the spent product with carbon-based filters to remove any trace of scent or characteristic taste, in gin there is no further filtering operation of the end product after distillation.

The residue of the filtering process to obtain the mash, consisting of spent rye, barley and wheat, a botanical mixture (herbs, spices, plants, berries and roots) and juniper, subjected to the processing procedure according to the invention, gives rise to a flour that will be called “gin flour”.

### Citrus Fruit-Based Liqueurs

The citrus fruit is washed, dried and immediately sent to manual peeling from which thin peelings are obtained. This operation is particularly complex because it is necessary to separate the yellow aromatic part of the peel from the white pectin. The peelings are immersed in stainless steel tanks containing pure alcohol and water to permit aromatic release (maceration).

After about a week, the process is considered to be finished and the peelings are removed from the tank, pressed and eliminated from the productive cycle. The fruity water-alcohol solution that is thus obtained is filtered and stored in a tank for the rest of the season.

During the step of production in the general mixing tank, the pure alcohol, the syrup consisting of mineral water and sugar, and the water-alcohol citrus fruit solution are added and lastly brought up to volume with the mineral water. The obtained mixture is then filtered, collected in a storage tank, analyzed and then sent to the filling unit for filling of the previously rinsed and dried bottles.

The citrus fruit peelings obtained from alcoholic maceration, subjected to the processing procedure according to the invention, give rise to a flour that will be called “citrus fruit liqueur flour”.

### Citrus Fruit Based Alcoholic Distillates

The citrus fruit is washed, dried and immediately sent to manual peeling from which thin peelings are obtained. This operation is particularly complex because it is necessary to separate the yellow aromatic part of the peel from the white pectin. The peelings are immersed in stainless steel tanks containing pure alcohol and water to permit aromatic release (maceration).

After about a week, the process is considered to be finished and the peelings are removed from the tank, pressed and eliminated from the productive cycle. The fruity water-alcohol solution that is thus obtained is filtered and stored in a tank for the rest of the season.

The product that is thus obtained is subsequently distilled by using the same process disclosed previously in the distillation of gin.

The citrus fruit peelings obtained from alcoholic maceration, subjected to the processing procedure according to the invention, give rise to a flour that will be called “distilled citrus fruit flour”.

### Citrus Fruit-Based Non-Alcoholic Distillates

For the production of non-alcoholic distillates, the same procedure is used that was previously disclosed for creating alcoholic distillates, the difference is the fact that instead of infusing the citrus fruit peelings in the alcohol, the citrus fruit peelings are infused in hot water so as to thus extract the essential oils without however giving an alcohol content to the finished product.

Also in this case, the flour obtained from the citrus fruit peelings with the procedure according to the invention will be called “distilled citrus fruit flour”.

### Cider

Cider is an alcoholic beverage that is obtained from the fermentation of apple juice: the alcohol content varies from 2% to 8% by volume.

After being harvested, the apples are reduced to a mush known as “pomace” (similar to marc) by the use of “cider mills” (mills or presses for cider).

The pulp is then transferred to the cider presses, where it is laid in layers known as “cheeses”.

Once this part has been terminated, the entire block is subjected to increasing pressure and temperatures until all the juices of the fruit have been collected.

The juice obtained is then filtered and poured into vats or barrels whilst the remaining pulp is reused in farms as feed.

Fermentation occurs at a temperature that oscillates between 4 and 16 degrees, and if the temperature seems low, it is ideal for making cider because the longer fermentation lasts, the more aromatic the cider will be.

A moment before the fermentation process consumes all the sugars, the cider is poured into new vats so that the inactive parts of the yeast remain at the bottom of the preceding vats. At this point, it is necessary to prevent that contact with the air produces bacteria, and this is why the vats are filled completely, preventing any possible air infiltration.

The fermentation of the remaining sugars generates a small quantity of carbon dioxide that forms a kind of protective layer on the liquid and it is at this point that sugars are added—if necessary.

Cider is ready after three months of fermentation, although it is most often left in the vats to age for two or three years.

The residual spent pomace, separated after fermentation, subjected to the processing procedure according to the invention, gives rise to a flour that will be called “cider flour”.

### Tequila

Production

Tequila is a distillate obtained from Agave tequilana or blue agave, where only the central part, known as piña, is used for producing the distillate, this is the part of the plant that is rich in inulin, the carbohydrate from which the sugars are extracted to start fermentation.

In the classic method, the fibres of the agave are steamed for about 36 hours. In an industrial context they are cooked in pressurized autoclaves at a temperature of 121° C. for a period of only six hours. In this step, the fibres are softened, releasing various soluble substances, mostly sugary, and generating a mash called “aguamiel” consisting of a liquid part and a solid part.

The aguamiel is fermented in large open containers with the addition of yeast used only to accelerate fermentation.

The alcohol content that the product has to reach after fermentation must be between 4% and 9% by volume.

In distillation, depending on the type of instruments used, more or fewer scents can be extracted that will then characterize the finished product.

Subsequently, the fermented aguamiel is subjected to filtration that separates the mash from the solid fibres of the agave.

This fermented mash is then distilled a first time so as to produce what is called ordinary, which is in turn distilled a second time so as to produce tequila plata, blanca or joven, which can be aged in wooden barrels so as to change the characteristic colour and taste of the tequila, which is then called reposado or añejo.

The most common content of alcohol for tequila is between 37.5% and 40% by volume

The residual Agave fibre, separated after fermentation, subjected to the processing procedure according to the invention, gives rise to a flour that will be called “Tequila flour”.

### Sake

Once the rice has been harvested, a part is covered with koji (Aspergillus oryzae, the spore that causes saccharification), which transforms the carbohydrate of the rice into simple sugars (glucose), enabling fermentation thereof.

Sake is produced only in the winter because fermentation produces heat and the outside cold helps controls the temperature with rice, water and koji, which are responsible for body, taste and aromas.

The subsequent steps involve creating the mother of the sale (shubo) and fermentation (known as multiple parallel, typical and unique in sake), which can also last up to 32 days. The duration is decided by the toji (the sake master, the equivalent of an oenologist for wine) who modifies the duration according to the type of product that he wishes to obtain. Filtering, sedimentation, pasteurization (if necessary), maturation, dilution and in some cases ageing (in barrels or bottles).

After fermentation, the toji filters the shubo, from which a waste product is obtained consisting of spent rice and koji.

This waste product, separated after fermentation, subjected to the processing procedure according to the invention, gives rise to a flour that will be called “sake flour”.

### SUMMARY OF THE INVENTION

As can be seen from the preceding descriptions, one of the main challenges in this field, in this sense, consists of the need to recover and reuse for different purposes the production waste of different products like beer, spirits, alcoholic and non-alcoholic citrus fruit distillates, cider, sake, represented by brewers' grains, skins, spent yeasts and process water, which overall represent about 90% of the raw materials used.

In particular, the brewers' grains and the skins are characterized by a water content comprised between 70 and 80% that, together with the high organic substance content, makes them particularly unstable because they are easily putrescible. Until today, processes are known for transforming brewers' grains into animal feed that nevertheless has drawbacks like the need for the transfer to the livestock facility to be substantially immediate because of the instability of the raw material, storage thereof being practically impossible.

The present invention intends to overcome the cited drawbacks.

In particular, one of the objects of the invention is to devise a recovery process for recovering waste from the production of products like beer, whisky, vodka, gin, tequila, liqueurs or citrus-fruit based distillates, cider, sake, soy sauce, which enables the environmental sustainability of the production line to be increased.

Another object of the present invention is to devise a procedure for recovering the waste from the production of the aforesaid products that enables food products to be obtained, in particular food products for human consumption.

Yet another object of the present invention is to devise a procedure for recovering the waste from the production of the aforesaid products that is easy and cheap to run and at the same time does not generate significant amounts of further waste that has to be disposed of.

Not least, one object of the present invention is to make food products resulting from the processing of production process waste of products such as beer, whisky, vodka, gin, tequila, liqueurs or citrus-fruit based distillates, cider, sake, soy sauce, said food products having to have a high fibre content and being able to promote on the organism those positive effects that are typical of the consumption of foodstuffs with a high fibre content, such as for example slowing down and decreasing the assimilation of nutrients, increasing the sense of satiety, improving intestinal motility, reducing the glycaemic index of the carbohydrates and the risk of cardiovascular diseases and colon cancer.

### DETAILED DESCRIPTION OF THE INVENTION

The method according to the invention is based on the recovery of a wet mass of waste materials, such as, for example, brewers' grains or skins, arising from the production processes for producing products like beer, whisky, vodka, gin, tequila, liqueurs or citrus-fruit based distillates, cider, sake, soy sauce and which develops in the following steps:
1. adding an enzyme to said waste materials that is suitable for breaking down possible gluten residues so as to make the end product completely devoid of gluten, said enzyme acting for a period comprised between 15 and 30 minutes;
2. boiling said waste materials for at least 20 minutes to reduce to zero the bacterial content and deactivate said enzyme and other possible enzymes present in said waste materials;
3. cooling and centrifuging said waste materials to eliminate most of the water present, centrifugation being preferred to pressing because it is a process that stresses said materials less and maintains the materials completely whole, not modifying the organoleptic properties of the end product;
4. drying at a temperature comprised between and 70 and 100° C. for a time comprised between 60 and 120 minutes, by a radio frequency dryer that enables said materials to be dried without affecting the organoleptic properties thereof; a product being obtained at the end of said drying that has a relative humidity comprised between 14 and the 2%;
5. milling said product, for example by a hammer mill, until a product is obtained with a particle size that is variable between 1 and 0.2 mm;
6. micronization of said product in a micronizing device, until the particle size of the product has been taken to a dimension comprised between 100 and 400 micron, making the product a flour that can be used for any food preparation.

Before starting the processing of said waste materials, said materials can be stored for a period not exceeding 48 hours, in suitable thermal containers, i.e. thermally isolated containers, so as to diminish the fermentation process by maintaining the “heat chain” to counteract the formation of possible moulds if said materials are the results of the production of a whisky, beer, vodka and gin, liqueurs or citrus-fruit based distillates, tequila, sake and have been previously processed by the heat cycle.

If on the other hand said waste materials result from the production of liqueurs or citrus-fruit based distillates, cider, soy sauce, beer (from the recovery of hops after the “dry hopping” step) and were previously processed with the cold cycle, storage can be provided for a period not exceeding 48 hours, in suitable cooled containers, so as to slow the fermentation process and the formation of possible moulds.

With regard to the step of drying in a radio frequency dryer, it is pointed out that when a dielectric material (in our case the brewers' grains or the peel) is subjected to the action of an outer electromagnetic field, the molecules of which it consists undergo a phenomenon that is called polarization: the electric dipoles are arranged according to the direction of the electric field applied. Using an oscillating field induces a vibrational-rotational effect of the molecules (in particular dipolar molecules like water) or of the spatial charges: if the polarity of the outer field is periodically reversed, the dipoles are forced to undertake an oscillating movement (with the same frequency) to be realigned with the field. At high frequencies, typically in the field of radio frequency comprised between 15 and 100 MHz, where the field polarity is reversed several million times per second, the rapid oscillation and the resulting intermolecular friction cause a dissipation of energy in the form of heat because part of the energy conferred by the outer magnetic field is absorbed by the molecules that start to vibrate and transform the energy into thermal energy. These phenomena, which generate great dissipation of kinetic and magnetic energy in the form of heat, give rise to homogeneous heating action regardless of the dimensions, the weight, density and thermal conductivity of the product subjected to drying. Further, it is possible to avoid the problem of localized overtemperatures because the radio frequencies act throughout the mass of the product, but only where the dielectric is present (in our case the water). A radio frequency drying plant mainly consists of a tunnel with one or more levels (depending on the productive capacity of the plant) within which the product to be dried advances by chains or belts. The electromagnetic waves are generated by a generator of radio frequencies, connected between two electrodes in the middle of which the product to be dried advances. During the drying process, the water present in the product is heated uniformly and instantaneously throughout the mass of the product, whatever the form thereof. This activates instantaneously the evaporation processes of the water and the transmigration of the water from the inner part to the surface of the product, to then evaporate by meeting the air inside the dryer that has a relative humidity that is much lower so that it is very receptive to the water. There is thus linear drying from the inside to the outside without meeting obstacles due to the various humidity gradients that are encountered in the case of drying by hot air. This enables faster drying times to be obtained, with lower drying temperatures that do not compromise the chemical and biological properties of the product, and energy saving, because only energy to evaporate the water is supplied and heat dispersal does not occur to heat the entire environment and the surrounding structures. The maximum 35% efficiency of a hot air thermal system is increased to 70% with this system.

Features of the Products Obtained after the Drying and Grinding Process

### Beer and Whisky

In this case, the end product is comparable, because the production process and the raw materials used are completely identical until the brewers' grains are removed from the process. In the case of beer, the hops will then be added (which according to our invention will also be recovered and subsequently dried and added in a percentage that is variable from 1 to 10% to the brewers' grains flour to create the beer flour (or used singly for other preparations) and the yeasts that will give rise to the second fermentation, whilst in the case of the whisky, distillation will occur.

The flour obtained will have a particle size comprised between 100 and 300 microns, with a fibre content that is variable between 35% and 50% by weight, and relative humidity comprised between 2% and 10% by weight. A beta glucans content comprised between 1% and 2% by weight, low carbohydrate content.

### Cider

The flour obtained will have a particle size comprised between 100 and 300 microns, with a fibre content that is variable between 30% and 40% by weight, and relative humidity comprised between 2% and 10% by weight. It contains vitamins of the groups A, B1, B2, C and has a high iron, potassium and calcium content.

### Vodka and Gin

The flour obtained will have a particle size comprised between 100 and 300 microns, with a fibre content that is variable between 25% and 45% by weight, and relative humidity comprised between 2% and 10% by weight. It contains vitamins of the groups A, B1, B2, C and a high iron potassium and calcium content. The properties of the flour in this case may vary according to the basic product used (potatoes, wheat or another cereal).

### Liqueurs or Citrus-Fruit Based Distillates, Both Alcoholic and Non-Alcoholic

The flour obtained will have a particle size comprised between 100 and 300 microns, with a fibre content that is variable between 40% and 50% by weight, and relative humidity comprised between 2% and 10% by weight. The flour contains vitamins of the C group and a large amount of calcium.

### Sake

The flour obtained will have a particle size comprised between 100 and 300 microns, with a fibre content that is variable between 40% and 50% by weight, and relative humidity comprised between 2% and 10% by weight. This flour is an important source of high quality proteins and fats, it is rich in vitamins of groups B and E and has antioxidant properties.

### Tequila

The flour obtained will have a particle size comprised between 100 and 300 microns, with a fibre content that is variable between 20% and 30% by weight, and relative humidity comprised between 2% and 10% by weight. It contains large amounts of vitamins of the C group and folates.

### Use of the Products Obtained by the Process According to the Invention.

The obtained products can be used according to the following modes:
1. pure
2. mixed, in a percentage comprised between 1% and 60%, with other types of flour resulting from:
   a. cereals such as durum wheat, soft wheat, maize, rice, oats, barley, spelt, teff, buckwheat, quinoa, amaranth, rye, bulgur wheat, fonio, millet, Khorasan wheat (kamut);
   b. vegetables such as carob, linseed, almonds, cocoa, cashew nuts, pulses (chickpeas, peas, broad beans, soy, beans, lentils) sesame, potatoes, yam, plantains, tapioca, chestnuts, algae;
   c. animals such as cricket flour, locust flour, silkworm flour, honey larvae flour, scorpion flour, Tenebrio molitor flour, snail flour.

1. A method for obtaining a food product from a wet mass of waste materials arising from the production processes for producing products like beer, whisky, vodka, gin, tequila, liqueurs or citrus-fruit based distillates, cider, sake, soy sauce, characterized in that it includes the following steps:
adding to said waste materials an enzyme that is suitable for breaking down possible gluten residues in said materials and making said enzyme act for a period comprised between 15 and 30 minutes;
boiling said waste materials for a time of at least 20 minutes;
cooling and centrifuging said waste materials to eliminate most of the water present therein;
drying said materials at a temperature comprised between 70° C. and 100° C. for a time comprised between 60 and 120 minutes, by radio frequency dryer so as to obtain, at the end of said drying, a product with relative humidity comprised between 14 and 2%.

2. The method according to claim 1, wherein said drying occurs by radiating said materials with electromagnetic waves at a frequency comprised between 15 MHz and 100 MHz.

3. The method according to claim 1, wherein after said drying grinding said product is provided until a product with a particle size variable between 1 and 0.2 mm is obtained.

4. The method according to claim 3, wherein after said grinding, said product is micronized until the particle size thereof is taken to a value comprised between 100 microns and 400 microns.

5. The method according to claim 1, wherein, before said adding, said waste materials are stored in a thermally insulated container, for a period not exceeding 48 hours.

6. The method according to claim 1, wherein, before said adding, said waste materials are stored in a cooled container, for a period not exceeding 48 hours.

7. A food product obtainable with the method of claims 1 to 6, characterized in that it consists of beer flour obtained by mixing barley malt flour with a percentage in weight comprised between 90% and 99% and hop flour with a percentage in weight comprised between 1% and 10%.

8. A food product characterized in that it includes a percentage by weight comprised between 1% and 60% of at least one flour obtainable with the method according to any one of claims 1 to 6, from waste materials arising from the production processes for producing products like beer, whisky, vodka, gin, tequila, liqueurs or citrus-fruit based distillates, cider, sake, soy sauce, and at least one cereal flour, or a vegetable flour, or an animal flour, in a percentage by weight comprised between 40% and 99%.

9. The food product according to claim 8, wherein said at least one cereal flour is chosen from a group comprising durum wheat flour, soft wheat flour, wheat flour, maize flour, rice flour, oat flour, barley flour, spelt flour, teff flour, buckwheat flour, quinoa flour, amaranth flour, rye flour, bulgur wheat flour, fonio flour, millet flour, Khorasan wheat flour.

10. The food product according to claim 8, wherein said at least one vegetable flour is chosen from a group comprising carob flour, linseed flour, almond flour, coconut flour, cashew flour, legume flour, sesame flour, potato flour, yam flour, green banana flour, tapioca flour, chestnut flour, alga flour.

11. The food product according to claim 8, wherein said at least one animal flour is chosen from a group comprising cricket flour, locust flour, silkworm flour, honey larvae flour, scorpion flour, mealworm flour, snail flour.
